(19) United States
(12) Patent Application Publication
(10) Pub. No.: US 2023/0237085 A1
(43) Pub. Date: Jul. 27, 2023

(54) OBJECT TAGGING LANGUAGE FOR CATEGORIZING OBJECTS PROCESSED BY SYSTEMS

(71) Applicant: salesforce.com, inc., San Francisco, CA (US)

(72) Inventor: Swaroop Jayanthi, Hyderabad Telangana (IN)

(21) Appl. No.: 17/583,116

(22) Filed: Jan. 24, 2022

(51) Int. Cl. G06F 16/35; G06F 16/33; G06F 16/31

(52) U.S. Cl. CPC G06F 16/355; G06F 16/3344; G06F 16/31

(57) ABSTRACT

A system allows users to perform analysis of objects processed by systems, for example, requests, traces, logs, and so on. The system allows users to use an object tagging language to categorize objects. Tagging rules specified using the object tagging language are executed to tag the objects processed. The system created a tagging metadata index based on the tagged objects. The tagging metadata index allows efficient execution of queries used for analyzing the objects. The system may be used for analyzing execution of systems, for example, to compare execution of replicas of a system to determine whether there are differences in the execution of different replicas.

### BACKGROUND

### Field of Art

This disclosure relates in general to processing of objects processed by systems or applications, for example, requests and traces, and in particular to an object tagging language for categorizing objects processed by systems.

### Description of the Related Art

Several applications require analyzing objects processed by systems, for example, requests processed by applications, reports generated by applications, or traces generated by systems such as database management systems. For example, systems and applications are often migrated from physical datacenters to cloud platforms such as AWS (AMAZON WEB SERVICES), GOOGLE cloud platform, MICROSOFT AZURE. Various objects processed by these systems are analyzed to determine whether the migration and subsequent execution of the systems is as expected. Such systems generate large number of objects, for example, a typical system may generate several hundred thousand objects that need to be analyzed.

In a multitenant system, different tenants may run different applications and may even run proprietary code. Therefore, there is no consistent format of the objects that need to be analyzed. For example, different applications or systems may log data using different formats and even unstructured data. Even replicas of a replicated system that run on different platforms may generate traces that have different formats. For example, one replica of an application may use an ORACLE database, whereas another replica may use a different database such as POSTGRESQL database. These two replicas may generate traces using different formats. Accordingly, it is difficult to analyze the traces of the two replicas to determine whether the execution of the two replicas matches. For example, it is possible that one of the traces includes errors or warning that are not logged in the trace generated by the other replica. The varied nature of the objects processed by such systems makes it difficult to analyze the processed objects and monitor execution of these systems.

### BRIEF DESCRIPTION OF DRAWINGS

FIG. 1 is a block diagram of a system environment illustrating a multi-tenant system using cloud platforms according to an embodiment.

FIG. 2 is a block diagram illustrating a replicated application in a cloud platform that generates objects, according to an embodiment.

FIG. 3 is a block diagram illustrating the system architecture of an object tagging system according to an embodiment.

FIG. 4 is a block diagram illustrating the architecture of an object tagging module according to an embodiment.

FIG. 5 is a flow chart illustrating the process for tagging objects according to an embodiment.

FIG. 6 is a block diagram illustrating a functional view of a typical computer system for use in the environment of FIG. 1 according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “115a,” indicates that the text refers specifically to the element having that particular reference numeral. A reference numeral in the text without a following letter, such as “115,” refers to any or all of the elements in the figures bearing that reference numeral.

### DETAILED DESCRIPTION

A system allows users to perform analysis of objects processed by systems, for example, requests, traces, logs, and so on. The system allows users to use an object tagging language to categorize objects. The system created a tagging metadata index based on the tagged objects. The tagging metadata index allows efficient execution of queries used for analyzing the objects.

According to an embodiment, the system (e.g., an online system or a multi-tenant system) receives from one or more systems, objects processed by the systems, for example, traces based on execution of the systems. A trace includes a set of trace objects. A trace object includes a set of fields. One or more fields may store unstructured data. A trace object has an identifier.

The system receives a declarative tagging specification comprising tagging rules. A tagging rule specifies criteria for identifying a category of a trace object. A criterion may describe a pattern of unstructured data stored in a field that is specific to a category of the trace object. The system executes the tagging rules of the tagging specification for the objects. The execution causes at least some of the objects to be annotated with tags. A tag for an object identifies a category of the object. The system generates a tagging metadata index that maps categories of tags to identifiers of objects. The system receives a query for analyzing the objects and executes the query using the tagging metadata index. The use of the tagging metadata index allows efficient analysis of the objects processed by the system.

### Overall System Environment

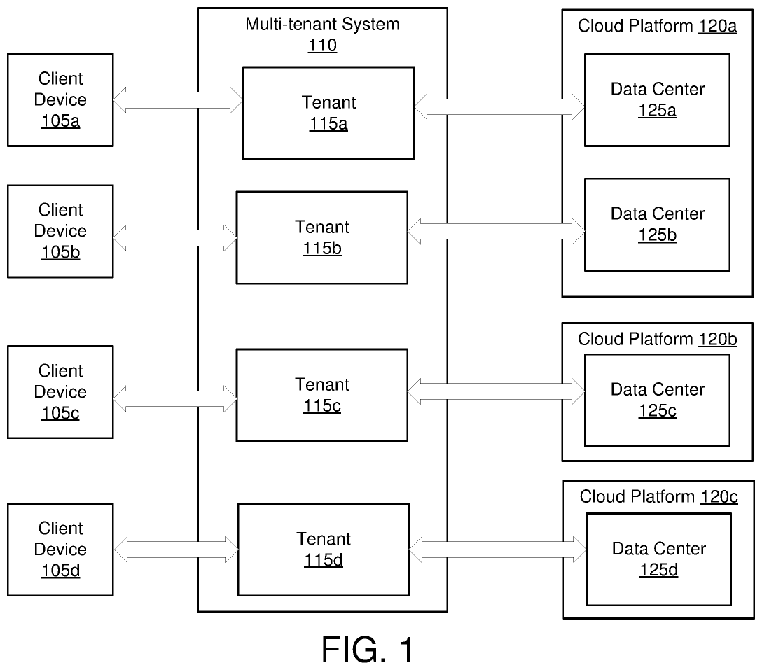

FIG. 1 is a block diagram of a system environment illustrating a multi-tenant system configuring data centers on cloud platforms according to an embodiment. The system environment 100 comprises a multi-tenant system 110, one or more cloud platforms 120, and one or more client devices 105. In other embodiments, the system environment 100 may include more or fewer components.

The multi-tenant system 110 stores information of one or more tenants 115. Each tenant may be associated with an enterprise that represents a customer of the multi-tenant system 110. Each tenant may have multiple users that interact with the multi-tenant system via client devices 105. With the multi-tenant system 110, data for multiple tenants may be stored in the same physical database. However, the database is configured so that data of one tenant is kept logically separate from that of other tenants so that one tenant does not have access to another tenant's data, unless such data is expressly shared. It is transparent to tenants that their data may be stored in a table that is shared with data of other customers. A database table may store rows for a plurality of tenants. Accordingly, in a multi-tenant system, various elements of hardware and software of the system may be shared by one or more tenants. For example, the multi-tenant system 110 may execute an application server that simultaneously processes requests for a number of tenants. However, the multi-tenant system enforces tenant-level data isolation to ensure that jobs of one tenant do not access data of other tenants.

A cloud platform may also be referred to as a cloud computing platform or a public cloud environment. A tenant may use the cloud platform infrastructure language to provide a declarative specification of a data center that is created on a target cloud platform 120. A tenant 115 may create one or more data centers on a cloud platform 120. A data center represents a set of computing resources including servers, applications, storage, memory, and so on that can be used by users, for example, users associated with the tenant.

The computing resources of a data center are secure and may not be accessed by users that are not authorized to access them. For example, a data center 125a that is created for users of tenant 115a may not be accessed by users of tenant 115b unless access is explicitly granted. Similarly, data center 125b that is created for users of tenant 115b may not be accessed by users of tenant 115a, unless access is explicitly granted. Furthermore, services provided by a data center may be accessed by computing systems outside the data center, only if access is granted to the computing systems in accordance with the declarative specification of the data center.

Examples of cloud platforms include AWS (AMAZON web services), GOOGLE cloud platform, or MICROSOFT AZURE. A cloud platform 120 offers computing infrastructure services that may be used on demand by a tenant 115 or by any computing system external to the cloud platform 120. Examples of the computing infrastructure services offered by a cloud platform include servers, storage, databases, networking, security, load balancing, software, analytics, intelligence, and other infrastructure service functionalities. These infrastructure services may be used by a tenant 115 to build, deploy, and manage applications in a scalable and secure manner.

The multi-tenant system 110 may include a tenant data store that stores data for various tenants of the multi-tenant store. The tenant data store may store data for different tenants in separate physical structures, for example, separate database tables or separate databases. Alternatively, the tenant data store may store data of multiple tenants in a shared structure. For example, user accounts for all tenants may share the same database table. However, the multi-tenant system stores additional information to logically separate data of different tenants.

Each component shown in FIG. 1 represents one or more computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, video game system, etc. Each computing device stores software modules storing instructions.

The interactions between the various components of the system environment 100 are typically performed via a network, not shown in FIG. 1. In one embodiment, the network uses standard communications technologies and/or protocols. In another embodiment, the entities can use custom and/or dedicated data communications technologies instead of, or in addition to, the ones described above.

Although the techniques disclosed herein are described in the context of a multi-tenant system, the techniques can be implemented using other systems that may not be multi-tenant systems. For example, an online system used by a single organization or enterprise may use the techniques disclosed herein to create one or more data centers on one or more cloud platforms 120.

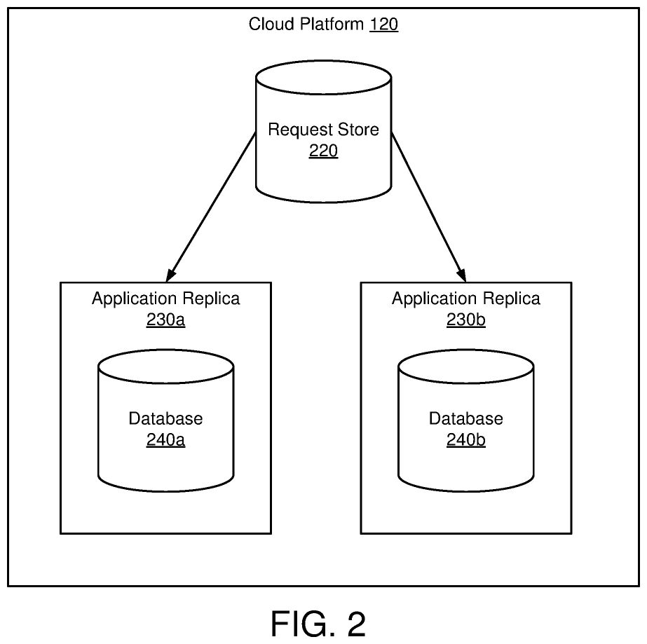

FIG. 2 shows an example replicated application that runs on the cloud platform and stores objects. The application 230 includes two replicas 230a and 230b that may run on different computing systems. The two replicas of the application 230 may run on geographically separate locations. There may be differences between the two application installations, for example replica 230a may use a database 240a provided by a particular vendor (e.g., ORACLE) whereas the replica 230b may use a database 240b provided by another vendor (e.g., IBM). Accordingly, the execution of the same request by the two application replicas 230 may have differences.

According to an embodiment, the cloud platform 120 receives requests for processing by the application 230. The received requests may be stored in a request store 220. The cloud platform 120 provides the requests received to both application replicas 230a and 230b. Each application replica 230a, 230b executes the requests received. Since there are differences in the installations of the application replicas 230a, 230b, it is likely that the same request may be processed differently by the two application replicas 230a, 230b. The execution of the requests may be different for other reasons, for example, the execution may depend on parameters such as location, time, some environment variables that is defined locally by an administrator, and so on that may be different when the request is executed by each application replica.

As an example, the same request may execute successfully in application replica 230a but return an error in application replica 230b. Alternatively, the same request may execute with warnings in application replica 230a but run without any warnings in application replica 230b. Similarly, it is likely that the same request returns in results that are different. For example, if the request returns a JSON (JAVASCRIPT OBJECT NOTATION) object as the result, the two application replicas may return JSON objects with differences in some of the attributes or differences in the structures of the returned object. The execution of the requests may generate different traces in the two application replicas. A trace refers to a sequence of logs that are generated and stored by an application or system that represents an execution of a task, for example, a beginning to end execution of a request processed by the system. Accordingly, the trace will store any error or warning generated during execution of the request. The execution of the requests may result in the two application replicas storing different logs.

A system may need to analyze the various objects associated with the application 230 to determine the differences in the execution of requests. For example, if the application was recently installed in the cloud platform, a system administrator may have to monitor the execution of the two application replicas to observe any differences. An application may be associated with a large number of requests, for example, millions of requests per day. As a result, the application or application replicas are associated with a very large number of objects that are stored by the system. Furthermore, each application may store objects such as traces or results in a proprietary format. Attributes of the objects may be scalar values, nested objects, unstructured data, semi-structured data, structured data, and so on. The variety of the formats of the data stored in the objects makes analysis of such objects difficult.

The system according to various embodiments allows users such as system administrators or data analysts to analyze objects processed by applications and systems, such as traces, logs, requests, and so on. Examples of traces analyzed by the system include database traces, result traces (traces that store responses generated by applications or systems), log traces, the error traces, the application tier traces, query language execution traces, and so on. The analysis of the traces may be performed to compare execution of two replicas of a system or application. The analysis of the traces may be performed to determine differences in execution of requests over a period of time, for example, to determine whether the system started generated errors or warnings over a period of time. The analysis of the traces may be performed to identify anomalies during execution of requests, for example, if there was a systemic change in execution time of requests over a time interval.

### System Architecture

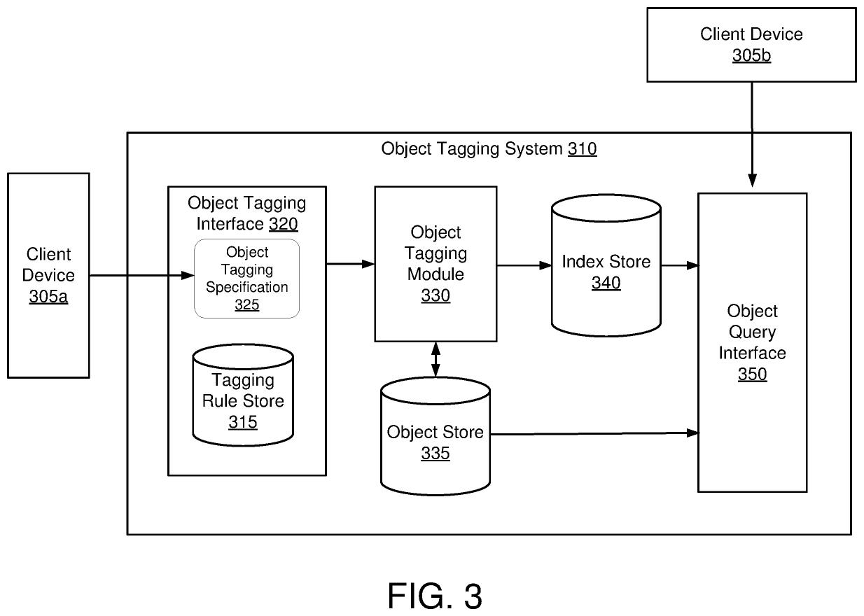

FIG. 3 is a block diagram illustrating the system architecture of an object tagging system according to an embodiment. The object tagging system 310 comprises an object tagging interface 320, an object tagging module 330, an object store 335, an index store 340, and an object query interface 350. Other embodiments can have different and/or other components than the ones described here, and that the functionalities can be distributed among the components in a different manner. The components shown in FIG. 3 may be part of different computing system and are not required to be executed on the same computing system. For example the data store may be available on a computing system running an application being analyzed and may be distinct from the computing system executing the object tagging module 330.

The object tagging interface 320 allows users to provide object tagging specification for tagging objects in a system. For example, a user associated with a tenant of a multi-tenant system may use a client device 305a to provide object tagging specification to tag traces generated by an application executed by the tenant. In an embodiment, the object tagging interface 320 allows users to use an object tagging language to provide a declarative specification for tagging objects. The declarative specification based on the object tagging language specifies declarative rules mapping patterns of objects to specific tags. The declarative tagging rules simply specify the mapping without requiring the users to specify how the mapping is implemented. The object tagging module 330 determines how the declarative specification is implemented. The object tagging interface 320 may present a graphical user interface that allows users to build declarative tagging rules. The object tagging interface 320 may allow users to invoke application programming interfaces (APIs) to specify declarative tagging rules. The object tagging interface 320 stores the receives declarative tagging rules in the tagging rule store 315. A declarative tagging rule may also be referred to herein as a tagging rule.

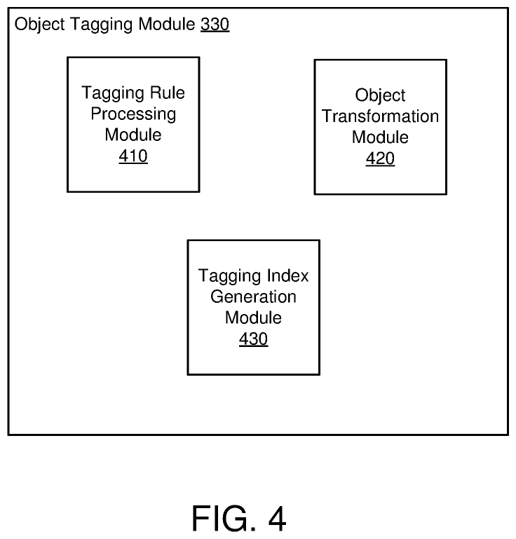

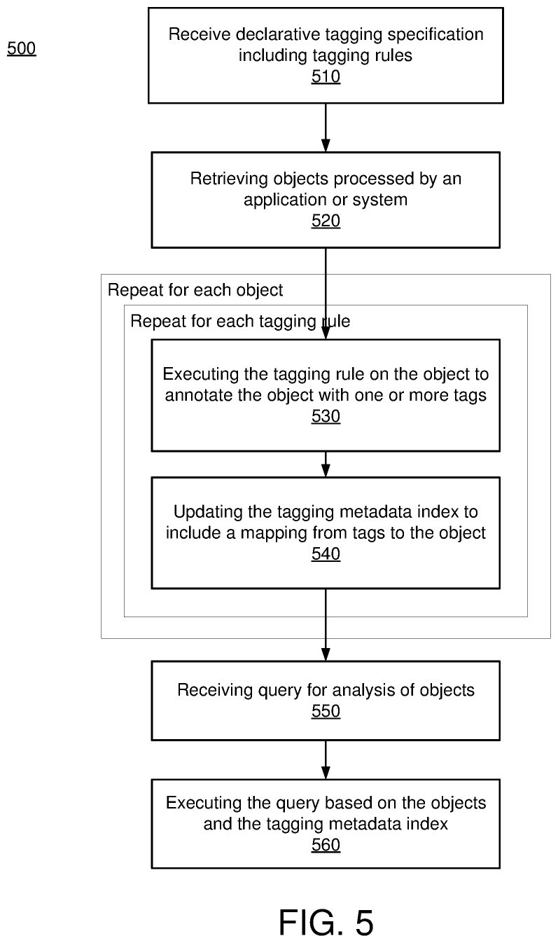

The object tagging module 330 receives a declarative specification comprising one or more declarative tagging rules and performs tagging of objects stored in a system according to the declarative specification. The object tagging module 330 receives declarative tagging rules and transforms and tags objects stored in an object store 335 based on category, expressions & filters specified in the declarative tagging rules. The object tagging module 330 executes the declarative tagging rules on an object to generate one or more of key/value pair of tags collection for the object based on the patterns defined in the declarative tagging rule. The framework supported by the object tagging system 130 allows users to specify custom tagging rules. For example, each tenant of a multi-tenant system may define a distinct set of rules. Accordingly, the same type of objects generated by different instances of the same application may be analyzed differently by different tenants of the multi-tenant system. The details of the architecture of the object tagging module 330 are provided in the FIG. 4 and the description of the FIG. 4. The process executed by the object tagging module 330 is shown in FIG. 5.

The object store 335 stores various types of objects that are analyzed by the object tagging system 130. The object store 335 may include one or more data stores. The object store 335 may be associated with one or more applications that are being analyzed by the object tagging system 130 and may be located in a system running the applications. The object store 335 stores objects including reports, traces (generated by databases or applications), logs, queries, requests, and so on that are analyzed by the object tagging system 130.

The index store 340 stores a tagging metadata index generated by the object tagging module 330. The tagging metadata index maps various tags to objects stored in the object store 335. An object is associated with an object identifier that allows the system to uniquely identify the object. The individual objects may be identified using object identifiers. The tagging metadata index allows efficient execution of queries for analyzing the objects.

The object query interface 350 allows users to query objects stored in the object store 335 for analysis purposes. For example, the object query interface 350 may provide a graphical user interface that allows a user to extract portions of traces that represent error or warnings. The object query interface 350 may provide a graphical user interface that allows a user to compare execution of a set of requests across two replicas of the an application. The execution of the object queries uses the tagging metadata index for efficient execution of the user requests.

As shown in FIG. 3, a user uses the client device 305a to provide an object tagging specification 325 using the object tagging interface 320. The object tagging specification 325 is provided to the object tagging module 330 that parses the object tagging specification to perform syntactic and semantic analysis of the declarative tagging rules to validate the rules. The object tagging module 330 builds a data structure representing the declarative tagging rules for efficient processing of the declarative tagging rules. The object tagging module 330 accesses objects stored in the object store 335 and processes them in accordance with the declarative tagging rules. The object tagging module 330 may transform the objects to add tags to the objects based on the declarative tagging rules. The declarative tagging rules may add mappings from tags to objects in the tagging metadata index stored in the index store 340. The object query interface 350 receives queries from users, for example, via client device 305b and analyzes the queries using objects stored in the object store 335 and the tagging metadata index.

FIG. 4 is a block diagram illustrating the architecture of an object tagging module according to an embodiment. The object tagging module 330 includes a tagging rule processing module 410, an object transformation module 420, and a tagging index generation module 430. Other embodiments may include more, fewer, or different modules than those indicated herein in FIG. 3.

The tagging rule processing module 410 obtains the declarative tagging rules from the object tagging interface 320 and parses the rules to perform syntactic and semantic analysis of the declarative tagging rules to validate them. If the tagging rule processing module 410 determines a syntactic or semantic error in a declarative tagging rule, the tagging rule processing module 410 may report the error to the user, for example, via the object tagging interface 320. The user may revise the declarative tagging rule to fix any errors. The tagging rule processing module 410 may receive a modified version of the declarative tagging rule via the object tagging interface 320 and analyze the declarative tagging rule again.

The object transformation module 420 accesses objects from the object store 335 and processes the declarative tagging rules applicable to the objects. The object transformation module 420 transforms the objects according to the declarative tagging rules applicable to the objects and may add one or more tags to the objects. The object transformation module 420 may store the transformed objects in the object store 335.

The tagging index generation module 430 generates and updates the tagging metadata index based on objects and declarative tagging rules processed by the object tagging module 330.

### Overall Process

FIG. 5 is a flow chart illustrating the process for tagging objects according to an embodiment. Other embodiments can perform the steps of FIG. 5 in different orders. Moreover, other embodiments can include different and/or additional steps than the ones described herein. The steps are indicated as being performed by a system, for example, the object tagging system 310. The steps may be performed by various modules of the object tagging system 310 including the object tagging module 330, object tagging interface 320, and so on.

The system receives 510 a declarative tagging specification. The declarative tagging specification comprising one or more tagging rules, wherein a tagging rule specifies criteria for identifying a category of a trace object, at least one criterion describing a pattern of unstructured data stored in a field, the pattern specific to a category of the trace object;

The system retrieves 520 from one or more systems, objects processed by the systems, for example, traces, requests, logs, and so on. For example, the traces generated by a system may include a set of trace objects. Each object includes a set of fields that may be stored as key-value pairs. The set of fields may include one or more fields storing unstructured data. An object has an object identifier that uniquely identifies the object.

The system executes the steps 530 and 540 for each object being processed and for each tagging rule of the declarative tagging specification that is applicable to the object being processed. The system executes 530 the tagging rule for the object. The execution causes the objects to be annotated with one or more tags. Each tag for the object may identify a category of the trace object, for example, database trace, result log, and so on. The system updates 540 the tagging metadata index to include a mapping from the tags that were used to annotate the object to identifiers of object being annotated.

The system receives 550 a query for analyzing the traces and executes 560 the query using the tag index.

### Various Embodiments and Examples

Following is an example rule tagging definition illustrating various attributes specified in a tagging rule.

```
[
  {
    ″ruleName″: ″″,
    ″message″: ″″,
    ″type″: ″″,
    ″status″: ″″,
    ″tags″: [
      {
        ″name″: ″″,
        ″message″: ″″,
        ″category″: [ // Different type of categories // ],
        ″criteria″: [ // List of criteria, to match the tag
          {
            ″name″: ″″,
            ″expression″: ″″
            ″type″:″″
          }
        ]
      } //end of tag
    ]
  }
] //end of rules definition
```

Examples of attributes of a tagging rule include a rule name that identifies and describes the rule, a rule type indicating whether the rule is a built-in rule or user specified rule, a status indicating whether the rule should be included or excluded during execution in a given context, a list of tags (each tag represented as a key value pair), a message that is appended with an object when the object is annotated with a particular tag, a category identifying the category of objects to which the tag is applied (for example, a classification category for classifying unstructured data, a result log category, a database trace category, a row count category for classifying rows as objects, and so on), one or more criteria that should be met by an object in order for the system to apply a particular tag to the object, and so on. According to an embodiment a criterion is represented as an expression, for example, a regular expression, a database query language expression, and so on. The expression is evaluated against an object to determine whether the tag should be applied to the object.

Following is an example tagging rule for processing a query language (QL) trace. The rule has name QLTrace. The rule specifies a tag QLStatement for finding generated QL statement. The tagging rule specifies two criteria, one named diffdateliteral that specifies a regular expression. The regular expression may check for patterns of String, Date, or Alphanumeric fields using wild card characters such as ‘*’ and ‘?’ and other regular expression features.

```
  {
    ″ruleName″: ″QLTrace″,
    ″message″: ″To search QL Trace in ResultLog trace″,
    ″type″: ″implicit″,
    ″status″: ″include″,
    ″tags″: [
      {
        ″name″: ″QLStatement″,
        ″message″: ″Tag to find the generated QL Statement″
        ″category″: [ ″resultLog_t ″ ],
        ″criteria″: [
          {
            ″name″: ″diffdateliteral″,
            ″expression″: ″TO_DATE(\\\\′[0-9]{2}-[0-9]{2}-[0-9]{4})\\\\′, \\\\′DD-MM-
  YYYY\\\\′)″,
            ″type″: ″re″
          },
          {
            ″name″: ″hasQlTextWithoutParameterValuesEqual″,
            ″expression″: ″%where%and%in%″,
            ″type″: ″re″
          }
        ]
      }
    ]
  },
```

The following tagging rule filters objects that store information describing cardinality. The tag name FilterCardinality specifies a criteria named Filter_criteria that executes a regular expression to identify a specific term in the objects of category classification_t and db_trace_t.

```
{
  ″ruleName″: ″cardinality″,
  ″message″: ″Filter cardinality″,
  ″type″: ″implicit″,
  ″status″: ″include″,
  ″tags″: [
    {
      ″name″: ″FilterCardinality″,
      ″message″: ″Tag for to find the cardinality″,
      ″category″: [ ″classification_t″, ″db_trace_t″ ]
      ″criteria″: [
        {
          ″name″: ″Filter_criteria″,
          ″expression″: ″%FilterCardinality%″
          ″type″: ″re″
        }
      ]
    }
  ]
},
```

The following tagging rule identifies reports that failed due to an error. The tag named LoadingReportsFailed specifies a criterion that checks for keywords that indicated failure in the objects.

```
{
    ″ruleName″: ″reports″,
    ″message″: ″Reports failed due to error″,
    ″type″: ″implicit″,
    ″status″: ″include″,
    ″tags″: [
      {
        ″name″: ″LoadingReportsFailed″,
        ″message″: ″Tag for report optimizer″,
        ″category″: [ ″classification_t″, ″resultLog_t″, ″db_trace″ ]
        ″criteria″: [
          {
            ″name″: ″Reports″,
            ″expression″: ″%Failed%″,
            ″type″: ″re″
          }
        ]
      }
    ]
  },
```

Following is a portion of an example object that may be generated by a system during execution, for example, while processing a request. The object includes various fields that may be stored as key-value pairs. Certain fields for example, ResultLog_t store unstructured text. An expert with knowledge of the objects generated by the system can identify patterns in the various fields that represent certain characteristics of execution of the system while processing the requests. Accordingly, the expert can provide tagging rules that match the patterns to determine the tags for each object.

```
{
  ″objname″: object1.json″,
  ″ComparisonTime″: 1631084454216,
  ″RunId″: ″54″,
  ″DB″: {
  ″RequestId″: ″0TQxx0000000009″,
  ″ResultLog_t″: ″Running soql query: GDPR: removed soql string\nGenerating a new sql
query\nNot considering filter QueryFilter[lhs=IsDeleted_gen_1,op=e, rhs=GdprRemoved]
for optimization because unindexed\nNot considering filter
QueryFilter[lhs=NumberOfEmployees,op=g, rhs=GdprRemoved] for optimization because
unindexed\nOn t scaleUp = 1.0\nOn cft scaleUp = 1.0\nConsidering optimizable
conditions:\nScanSelectiveFilter on table t\nUnique identifier for plan pinning:
ScanSelectiveFilter on table t entity ...″,
  ″Gets_t″: 2,
  ″Classification_t″: ″{\″WinningFilter\″:\″ScanSelectiveFilter on table t entity :
Account\″,\″UserLastModified\″:1621878103000,\″StableQueryHash\″:-
134038326508,\″TableSize\″:{\″Account\″:3...″RequestType\″:\″SOQL\″}″,
  ″DbTime_t″: 0,
  ″RequestType_t″: ″SQL″,
  ″Instance_t″: ″DatabaseInstance1″,
  ″filename″: ″file1.json″,
  ″Workload_t″: ″23200.0″,
  ″Elapsed_t″: 55,
  ″RowCount_t″: 3,
  ″DbTrace_t″:
  ″Request_t″: ″ProdDbHammerRequest{organizationId=00Dxx0000001gEb,
entityId=U#f06.3fffffff (ProdDbHammerRequest), captureSqlId=sqlid,
captureId=0TQxx0000000006}″ },
```

If the example tagging rules described herein are executed using the above example object, the following tags may be generated. These tags are added to the object and the transformed object annotated with these tags is stored. These tags may be added as a field of the object.

```
  ″Tags″: [
      { ″ruleName″:″gdprremoved″, ″tagName″: ″gdprobsolete″, ″msg″: ″GDPR removed
identified in ResultLog Trace″},
      { ″ruleName″: ″cardinality″, ″tagName″: ″FilterCardinality″, ″msg″: ″Filter Cardinality
changed for Account″ },
      { ″ruleName″: ″SoQLParametersfilters″, ″tagName″: ″SoQLStatement″, ″msg″: ″SoQL
trace found diff sql_diff dateliteral ″ }
    ],
```

Following is a portion of an example tagging metadata index that stores the mapping from tags to objects. The tagging metadata index maps tags to objects such as requests. The tagging metadata index identifies the objects using their respective identifiers. The tagging metadata index may store additional attributes for example, a category of the object, certain flags applicable to the object and so on. The additional metadata attributes stored in the tagging metadata index allow specific queries to be processed efficiently. For example, a user may be able to filter the requests based on specific attributes stored in the tagging metadata index.

```
[
  {
    ″tagName″: ″reportoptimizer″,
    ″ruleName″: ″coreoptimizer″,
    ″requests″: [
      {″requestId″:″0TQxx0000000009″, ″category″:[″reports″], ″oracle″:″Yes″, ″sdb″:″Not
Applicable″},
      {″requestId″:″0TQxx0000000018″, ″category″:[″reports″], ″oracle″:″Yes″, ″sdb″:″Not
Applicable″},
  ]
  },
  {
    ″tagName″: ″reportoptimizer″,
    ″ruleName″: ″coreoptimizer″,
    ″requests″: [
      {″requestId″:″0TQxx0000000009″, ″category″:[″reports″], ″oracle″:″Yes″, ″sdb″:″Not
Applicable″},
    ]
  },
]
```

The system disclosed allows efficient analysis of arbitrary objects processed by multiple heterogenous data sources. The system does not enforce any predetermined schema on the data representation of objects. The system receives tagging rules and extracts data and transforms the objects to annotate the objects with tags representing various categories and attributes describing the objects. This allows a user to add structure to unstructured and arbitrary objects processed by various systems. The system further created a tagging metadata index that allows users to efficiently search across the objects.

### Computer Architecture

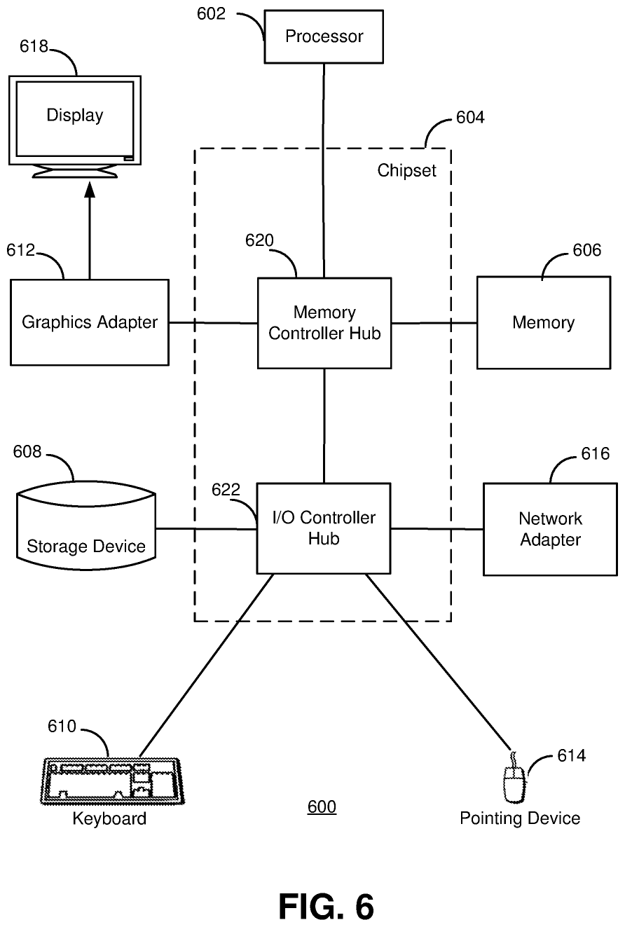

FIG. 6 is a high-level block diagram illustrating a functional view of a typical computer system for use as one of the entities illustrated in the environment 100 of FIG. 1 according to an embodiment. Illustrated are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is a non-transitory computer-readable storage medium, such as a hard drive, compact disk read-only memory (CD-ROM), DVD, or a solid-state memory device. The memory 606 holds instructions and data used by the processor 602. The pointing device 614 may be a mouse, track ball, or other type of pointing device, and is used in combination with the keyboard 610 to input data into the computer system 600. The graphics adapter 612 displays images and other information on the display 618. The network adapter 616 couples the computer system 600 to a network.

As is known in the art, a computer 600 can have different and/or other components than those shown in FIG. 6. In addition, the computer 600 can lack certain illustrated components. For example, a computer system 600 acting as a multi-tenant system 110 may lack a keyboard 610 and a pointing device 614. Moreover, the storage device 608 can be local and/or remote from the computer 600 (such as embodied within a storage area network (SAN)).

The computer 600 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 608, loaded into the memory 606, and executed by the processor 602.

The types of computer systems 600 used by the entities of FIG. 1 can vary depending upon the embodiment and the processing power used by the entity. For example, a client device 105 may be a mobile phone with limited processing power, a small display 618, and may lack a pointing device 614. The multi-tenant system 110 and the cloud platform 120, in contrast, may comprise multiple blade servers working together to provide the functionality described herein.

### ADDITIONAL CONSIDERATIONS

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes and may not have been selected to delineate or circumscribe the inventive subject matter. Accordingly, the disclosure of the embodiments is intended to be illustrative, but not limiting.

What is claimed is:

1. A computer implemented method for analyzing traces generated by systems, the method comprising:
receiving, by an online system, from one or more systems, traces based on execution of the one or more systems, wherein a trace comprises a set of trace objects, wherein a trace object includes a set of fields, the set of fields including one or more fields storing unstructured data, wherein a trace object has an identifier;
receiving a declarative tagging specification, the declarative tagging specification comprising one or more tagging rules, wherein a tagging rule specifies criteria for identifying a category of a trace object, at least one criterion describing a pattern of unstructured data stored in a field, the pattern specific to a category of the trace object;
executing the tagging rules of the tagging specification for the traces, the execution causing one or more trace objects to be annotated with tags, wherein a tag for a trace object identifies a category of the trace object; and
generating a tag index that maps categories of tags to identifiers of trace objects;
receiving a query for analyzing the traces; and
executing the query using the tag index.

2. The computer implemented method of claim 1, wherein a tagging rule specifies an expression representing a criteria corresponding to a tag.

3. The computer implemented method of claim 1, wherein the one or more systems execute on a cloud platform.

4. The computer implemented method of claim 1, wherein the online system is a multi-tenant system, wherein the declarative tagging specification is provided by a tenant of the multi-tenant system.

5. The computer implemented method of claim 1, wherein the one or more systems comprise a plurality of replicas of a system, the plurality of replicas comprising a first replica of the system and a second replica of the system, wherein the query for analyzing the traces determines a difference in execution of a set of requests between the first replica of the system and the second replica of the system.

6. The computer implemented method of claim 5, wherein the first replica of the system uses a first database from a first vendor and the second replica of the system uses a second database from a second vendor.

7. The computer implemented method of claim 5, wherein determining the difference in execution of the set of requests between the first replica of the system and the second replica of the system comprises determining whether an error is generated when a particular request from the set of requests is processed by the first replica of the system but no error is generated when the particular request is processed by the second replica of the system.

8. A non-transitory computer readable storage medium for storing instructions that when executed by a computer processor cause the computer processor to perform steps for configuring data centers in a cloud platform, the steps comprising:
receiving, by an online system, from one or more systems, traces based on execution of the one or more systems, wherein a trace comprises a set of trace objects, wherein a trace object includes a set of fields, the set of fields including one or more fields storing unstructured data, wherein a trace object has an identifier;
receiving a declarative tagging specification, the declarative tagging specification comprising one or more tagging rules, wherein a tagging rule specifies criteria for identifying a category of a trace object, at least one criterion describing a pattern of unstructured data stored in a field, the pattern specific to a category of the trace object;
executing the tagging rules of the tagging specification for the traces, the execution causing one or more trace objects to be annotated with tags, wherein a tag for a trace object identifies a category of the trace object; and
generating a tag index that maps categories of tags to identifiers of trace objects;
receiving a query for analyzing the traces; and
executing the query using the tag index.

9. The non-transitory computer readable storage medium of claim 8, wherein a tagging rule specifies an expression representing a criteria corresponding to a tag.

10. The non-transitory computer readable storage medium of claim 8, wherein the one or more systems execute on a cloud platform.

11. The non-transitory computer readable storage medium of claim 8, wherein the online system is a multi-tenant system, wherein the declarative tagging specification is provided by a tenant of the multi-tenant system.

12. The non-transitory computer readable storage medium of claim 8, wherein the one or more systems comprise a plurality of replicas of a system, the plurality of replicas comprising a first replica of the system and a second replica of the system, wherein the query for analyzing the traces determines a difference in execution of a set of requests between the first replica of the system and the second replica of the system.

13. The non-transitory computer readable storage medium of claim 12, wherein the first replica of the system uses a first database from a first vendor and the second replica of the system uses a second database from a second vendor.

14. The non-transitory computer readable storage medium of claim 12, wherein determining the difference in execution of the set of requests between the first replica of the system and the second replica of the system comprises determining whether an error is generated when a particular request from the set of requests is processed by the first replica of the system but no error is generated when the particular request is processed by the second replica of the system.

15. A computer system comprising:
a computer processor; and
a non-transitory computer readable storage medium for storing instructions that when executed by the computer processor, cause the computer processor to perform steps for configuring data centers in a cloud platform, the steps comprising:
receiving, by an online system, from one or more systems, traces based on execution of the one or more systems, wherein a trace comprises a set of trace objects, wherein a trace object includes a set of fields, the set of fields including one or more fields storing unstructured data, wherein a trace object has an identifier;
receiving a declarative tagging specification, the declarative tagging specification comprising one or more tagging rules, wherein a tagging rule specifies criteria for identifying a category of a trace object, at least one criterion describing a pattern of unstructured data stored in a field, the pattern specific to a category of the trace object;
executing the tagging rules of the tagging specification for the traces, the execution causing one or more trace objects to be annotated with tags, wherein a tag for a trace object identifies a category of the trace object; and
generating a tag index that maps categories of tags to identifiers of trace objects;
receiving a query for analyzing the traces; and
executing the query using the tag index.

16. The computer system of claim 15, wherein a tagging rule specifies an expression representing a criteria corresponding to a tag.

17. The computer system of claim 15, wherein the online system is a multi-tenant system, wherein the declarative tagging specification is provided by a tenant of the multi-tenant system.

18. The computer system of claim 15, wherein the one or more systems comprise a plurality of replicas of a system, the plurality of replicas comprising a first replica of the system and a second replica of the system, wherein the query for analyzing the traces determines a difference in execution of a set of requests between the first replica of the system and the second replica of the system.

19. The computer system of claim 18, wherein the first replica of the system uses a first database from a first vendor and the second replica of the system uses a second database from a second vendor.

20. The computer system of claim 18, wherein determining the difference in execution of the set of requests between the first replica of the system and the second replica of the system comprises determining whether an error is generated when a particular request from the set of requests is processed by the first replica of the system but no error is generated when the particular request is processed by the second replica of the system.
